(19) United States
(12) Patent Application Publication
(10) Pub. No.: US 2006/0212387 A1
(43) Pub. Date: Sep. 21, 2006

(54) Method and system for administrating funding of product development

(75) Inventor: Peter Albert Jensen, Brussels (BE)

Correspondence Address: BIRCH STEWART KOLASCH & BIRCH, PO BOX 747, FALLS CHURCH, VA, 22040-0747, US

(73) Assignee: Genzen Ltd., Hong Kong (HK)

(21) Appl. No.: 11/084,242

(22) Filed: Mar. 21, 2005

(51) Int. Cl. G06Q 40/00

(52) U.S. Cl. 705/39

(57) ABSTRACT

Systems and methods are provided for administrating funding of product development. The system may include a memory for storing a set of instructions and a processor for executing the set of instructions stored in memory to performed a method including establishing a list of entries; assigning a priority to each entry in said list; associating identifying information with at least one entry; and issuing an instruction upon determination that a predetermined condition has been fulfilled.

### BACKGROUND OF THE INVENTION

1. Field of the Invention

The present invention relates to a method and a system for funding product development, product manufacturing or any other form of providing new products or services based on pre-sale of the products to be developed.

2. Description of Background Art

Development of new products within highly sophisticated technological fields is often faced with funding problems. Traditionally a developer will seek to obtain the necessary funds from investors willing to accept the risk in view of the possibilities for profit if the product is successfully developed and marketed.

However, a candidate investor will prefer to invest in projects where the likelihood of success is perceived as large, where the horizon for profit is relatively close, and where the technology has already shown some degree of success. This creates a “chicken and egg” type problem for emerging technologies. Access to funds depends on some degree of initial success, which can only be achieved upon access to funds.

Furthermore, an investor will not normally consider the utility, or degree of benefit, a new product can bring to individuals or society, only the degree to which the product can meet a demand in the market.

A typical example could be development of organs or other implants based on tissue engineering. The technology is within reach, but it is difficult to see how investment in tissue engineering projects will result in products that can be marketed to a mass market. Other examples could be products or services within such fields as space flight, nanotechnology, or even attempts to raise the necessary funds to organize an event within the fields of entertainment or sports.

Consequently there is a need for alternative means and methods for gaining access to funds that can be utilized towards the development of new products through research, or in other ways develop or provide products or services that cannot easily be funded through traditional means of investment.

### SUMMARY OF THE INVENTION

Systems and methods are provided for administrating funding of product development. The system may include a memory for storing a set of instructions and a processor for executing the set of instructions stored in memory to performed a method including establishing a list of entries; assigning a priority to each entry in said list; associating identifying information with at least one entry; and issuing an instruction upon determination that a predetermined condition has been fulfilled.

Principles consistent with some embodiments of the present invention provide for a method for funding development of a product or a service, or otherwise financing the ability to be able to deliver a product or a service, through pre-sale of the product or service to customers. Principles consistent with some embodiments of the present invention also provide for a system for performing the method in a computerized environment.

Principles consistent with some embodiments of the present invention provide a method for funding product development through pre-sale of products to be developed may comprise establishing a list of entries where each entry represents a sale of a future product; assigning a priority for product delivery to each entry in said list; offering entries in said list for sale; receiving notification of at least one sale of an entry in the list; holding the funds resulting from any sales of entries in the list in an escrow account until a predetermined condition has been fulfilled; and transferring the funds from said escrow account to a second account holding funds available for product development or production when said predetermined condition has been fulfilled.

Alternatively, principles consistent with some embodiments of the present invention provide a method of providing funds towards product development by buying through a pre-sale a product to be developed, may comprise receiving an offer to purchase an entry in a list where each entry represents a sale of a future product; giving notification of acceptance of said offer to purchase an entry, said entry being associated with a defined priority for product delivery; and providing payment for the purchase in the form of funds to be held in an escrow account until a predetermined condition has been fulfilled.

Alternatively, principles consistent with some embodiments of the present invention provide a system for administrating funding of product development through pre-sale of products to be developed, may comprise a memory for storing a list of entries, each entry being assigned a priority; a registration module for receiving information identifying a customer and registering said customer identification information in said list in accordance with a corresponding priority; an electronic payment module capable of receiving electronic payment information corresponding with an entry of customer identification information in said list, and transmitting instructions indicating that funds relating to said payment information is to be placed in an escrow account in a banking system; and a monitoring device configured to detect the fulfillment of a predefined condition, and upon such fulfillment, transmit information representing an authorization to transfer funds accumulated in said escrow account to a second account in said banking system.

Alternatively, principles consistent with some embodiments of the present invention provide a computer program product containing a set of instructions, which are executed by one or more computer processors to perform a method of the invention.

### BRIEF DESCRIPTION OF THE DRAWINGS

Exemplary embodiments of the present invention will become more fully understood from the detailed description given hereinbelow and the accompanying drawings. These drawings are given by way of illustration only and, thus, are not limiting on the present invention. In the drawings, like reference numbers represent like elements, wherein:

FIGS. 1a and 1b depict an exemplary flowchart illustrating a method consistent with principles of some embodiments of the present invention;

FIG. 2 depicts an exemplary list of entries corresponding with a product delivery priority consistent with principles of some embodiments of the present invention;

FIG. 3 depicts an exemplary flowchart illustrating a method consistent with principles of some embodiments of the invention, from the customer perspective; and

FIG. 4 depicts an exemplary computerized system for performing and/or administrating a method consistent with principles of some embodiments of the invention.

### DETAILED DESCRIPTION OF THE INVENTION

Principles consistent with some embodiments of the present invention are directed to a method for funding development of a product or a service, or otherwise financing the ability to be able to deliver a product or a service, through pre-sale of the product or service to customers. The invention also provides a system for performing the method in a computerized environment.

For the purpose of simplicity, principles consistent with some embodiments of the present invention will hereinbelow be described as a method and a system for funding development of a product. It should, however, be understood that the term product may include services and events, and that development is not limited to research and development of physical products but should also be understood to include other efforts to bring forth new.

### Overview of the Method

Principles consistent with some embodiments of the present invention provide a method for funding product development through pre-sale of products to be developed, in which a list of entries representing a sale of a future product is created. To each entry in this list a priority for product delivery is assigned. The products are then pre-sold by way of selling entries in the list. According to some embodiments of the invention, the price of each entry may be a function of the product delivery priority associated with the entry.

The funds that are received in this manner are then held in an escrow account until a predetermined condition has been fulfilled, and only after this condition has been fulfilled are the funds transferred from said escrow account to a second account holding funds available for product development and/or production.

By letting the predetermined condition be associated with the amount of funds collected through the presale, customers can be certain that the price they pay for the product will not be lost on an underfunded attempt to develop or otherwise provide the product in question. According to some embodiments consistent with the principles of the present invention, funds are returned to the customers if the predetermined condition is not fulfilled within a certain time period, and the customers will not have lost their money.

According to one embodiment of the invention, the predetermined condition may be the sale of a predetermined number of entries in said list.

According to an alternative embodiment of the invention, the predetermined condition may be the sale of the entry with the highest product delivery priority in said list.

The predetermined condition may also simply be that the total funds held in the escrow account exceed a certain amount.

According to one embodiment of the invention a customer owning the entry with the highest priority will upon availability of a product, be offered to accept this product. He or she may then have the option to accept the product and have his or her entry in the list deleted, or defer, retain the entry in the list, and pass the option to accept the product to the customer owning the entry with the next lower priority. This customer will then be offered the same choice to accept or defer. The reasons why a customer might want to defer may be that different types of products are offered such that the customer may wait for a later offer that better suits his or her needs or preferences, or the customer might simply not need the product at this time, but will wish to maintain high priority for product delivery for some time in the future.

In the case were the product may actually be one of several types, or belonging to one of several groups of products, one embodiment of the invention provides for the allocation of the funds held in said escrow account into a plurality of sub-accounts each associated with one of the types of products or plurality of product groups. This allocation may be based on a preference indicated by each individual customer upon sale of an entry in said list. According to this embodiment the predetermined condition may actually be a set of a plurality of conditions, where each is associated with one of said plurality of sub-accounts and a corresponding one of said plurality of product groups. In this way customers will only provide funds towards the development of products of a type, or belonging to a product group, that they are most likely to accept in the future. One reason for doing things this way instead of simply creating one list for each product group, may be to provide customers with the option to change their product preference in the future without loosing their priority. Another reason is that by making the entries tradable, as will be discussed further below, an entry is more tradable because it can be sold to customers with a different product preference than the initial customer.

According to such an embodiment, funds from an escrow sub-account associated with a given product group will, upon fulfillment of a condition associated with a corresponding sub-account and a corresponding product group, be transferred to a sub-account of said second account, holding funds available for product development and/or production only of products belonging to the relevant product group.

Several alternatives are possible regarding the sale of entries in the list. According to one embodiment entries are sold sequentially, where an earlier customer pays a higher price and gets a higher priority than subsequent customers.

According to an alternative embodiment of the invention customers may be able to choose their priority and price. Entries in the list are then sold according to customer preference, such that an earlier customer can choose to buy an entry with a lower priority and lower price than subsequent customers. This will be particularly useful when the products are on the cutting edge of technology so that product development may take a long time, and particularly when each product must be developed or manufactured individually for each customer. One such example may be tissue engineering. Other examples include other biotechnological products, products within the field of nanotechnology, commercial space flights for individual customers, etc.

in such a case, some customers may be willing to pay a dramatically higher price for an entry with high priority, while other customers may be willing to wait for a substantially longer time. The option to buy an entry at a relatively low price and with a low priority even early on, and the possibility to buy a high priority entry, if one is still available, for a later customer with more urgent need of a product, would be beneficial to all parties.

According to some embodiments consistent with the principles of the invention, an owner of an entry may offer his entry up for sale to others. The method may then include receipt of a notification to change the customer name entered as an entry in the list. This may contribute to reduce the customer's risk even more, since it provides the customer with an exit if he or she no longer wants or needs the product, if the products that are finally offered fail to fulfill the customer's expectations, or for any other reason. In order to prevent undue speculation the number of entries one customer may own may be set to a certain maximum.

The actual implementation of the method may include a high degree of computerization in order to take advantage of electronic payment and banking systems, automatic monitoring of the predetermined conditions and for storage and retrieval of data. Individual steps of the method may also involve human judgment and intervention, such as the decision that a condition has been met, and the authorization of transfer of funds between accounts.

Particularly, a method according to principles consistent with the invention may involve storing the list on a computer system. If the method is performed using an e-commerce system, this computer system may be configured to present an offer for sale of entries in said list on a computer network.

The computer system may also be configured to evaluate said predetermined condition, and upon fulfillment of said condition, to issue an order to an electronic banking system authorizing the transfer of funds from the escrow account to the second account.

The invention also provides a method for providing funds towards product development by buying through a pre-sale a product to be developed. This method represents the steps performed by a customer, and corresponds closely to the method described above.

### Overview of the System

Principles consistent with some embodiments of the present invention also provide a system for administrating funding of product development through pre-sale of products to be developed.

The system may include a memory for storing a list of entries, each entry being assigned a priority; a registration module for receiving information identifying a customer and registering said customer identification information in said list in accordance with a corresponding priority; an electronic payment module capable of receiving electronic payment information corresponding with an entry of customer identification information in said list, and transmitting instructions indicating that funds relating to said payment information is to be placed in an escrow account in a banking system; and a monitoring device configured to detect the fulfillment of a predefined condition, and upon such fulfillment, transmit information representing an authorization to transfer funds accumulated in said escrow account to a second account in said banking system.

In one embodiment of the system according to the invention, the predetermined condition may be the registration of customer identification information in a predetermined number of entries in said list.

According to an alternative embodiment, the predetermined condition may be the registration of customer identification information in the entry with the highest product delivery priority in said list.

One embodiment of the invention further includes a communication module configured to receive information identifying that a product is available, to transmit an offer to accept said product to the customer identified in the entry associated with the highest priority in said list, and to receive information representing acceptance or rejection of said offer from said customer. The registration module may then be configured to handle information received by said communication module and. Upon receipt of an acceptance of an offer, the registration module may transmit an authorization to deliver said product to the customer from whom acceptance is received to a product delivery subsystem and delete the entry containing an identification of said customer from the list. Upon receipt of a rejection of an offer, the registration module may instruct said communication module to transmit said offer to the customer identified in the entry associated with the priority with the next lower priority relative to the customer from whom said rejection was received.

In another alternative embodiment of the system, the information received by the registration module may include information identifying a preference for a type of product, which will be referred to as a product group preference. In this case one entry in the list still represents the sale of one product, but the products offered may belong to one of a plurality of product groups. In the case where the products are organs produced through tissue engineering, the product groups may then represent different types of organs such as kidney, liver, heart etc. Similarly, if the funds will go towards searching for and restoring antiques, the product groups may include one group for furniture, one group for art objects, one group for jewelry, and so on.

The system may then be configured to store this information in the list together with said customer identification information. According to this embodiment, the electronic payment module may be configured to instruct the placement of said payment in a sub-account of the escrow account corresponding with the identified product group preference; and the monitoring device may be configured to discriminate between predefined conditions associated with one of said plurality of sub-accounts and a corresponding one of said plurality of product groups.

According to yet another embodiment of the invention, the monitoring device may be configured to, upon detection of fulfillment of a condition associated with one of said plurality of sub-accounts and a corresponding one of said plurality of product groups, transmit instructions representing an authorization to transfer funds accumulated in the escrow sub-account associated with that product group to a sub-account of the second account. This sub-account of the second account will then hold funds available for product development and/or production only of products belonging to the product group associated with the escrow sub-account from which the funds are transferred.

In some embodiments of the system according to the invention, the monitoring device may be configured to transmit, upon detecting that no predetermined condition has been fulfilled within a predetermined time, information representing an authorization to transfer said funds held in said escrow account back to customers owning entries in said list.

According to one embodiment of the invention, the system also includes an e-commerce subsystem connected to a publicly accessible communication network and capable of presenting information accessible from said communication network and representing a product for sale at a given price and with a given product delivery priority. The e-commerce subsystem may be configured to, upon each sale, transmit electronic payment information to the electronic payment module; and transmit information identifying a customer having purchased a product to the registration module. The e-commerce subsystem may then be configured to, upon each sale, reduce the price and product delivery priority offered to subsequent customers.

In an alternative embodiment of the e-commerce subsystem, the information representing a product for sale is presented as a list of product delivery priority and price options from which a customer can choose, and where lower priority may be given a lower price. The e-commerce subsystem may then be configured to, upon each sale, remove or otherwise disable the selected product delivery priority and price from said list of product delivery priority and price options.

According to yet another embodiment of the invention, the e-commerce subsystem may be configured to receive information indicating that an entry that has already been sold is offered for sale by the owner, present the entry in a list of entries available for trade, and, upon each trade, transmit to the electronic payment module, instructions to receive payment on behalf of an identified seller; transmit, to the registration module, information identifying a customer having purchased a product and an identification of the traded entry; and remove the entry from the list of entries available for trade.

### Description of Exemplary Embodiments of the Method

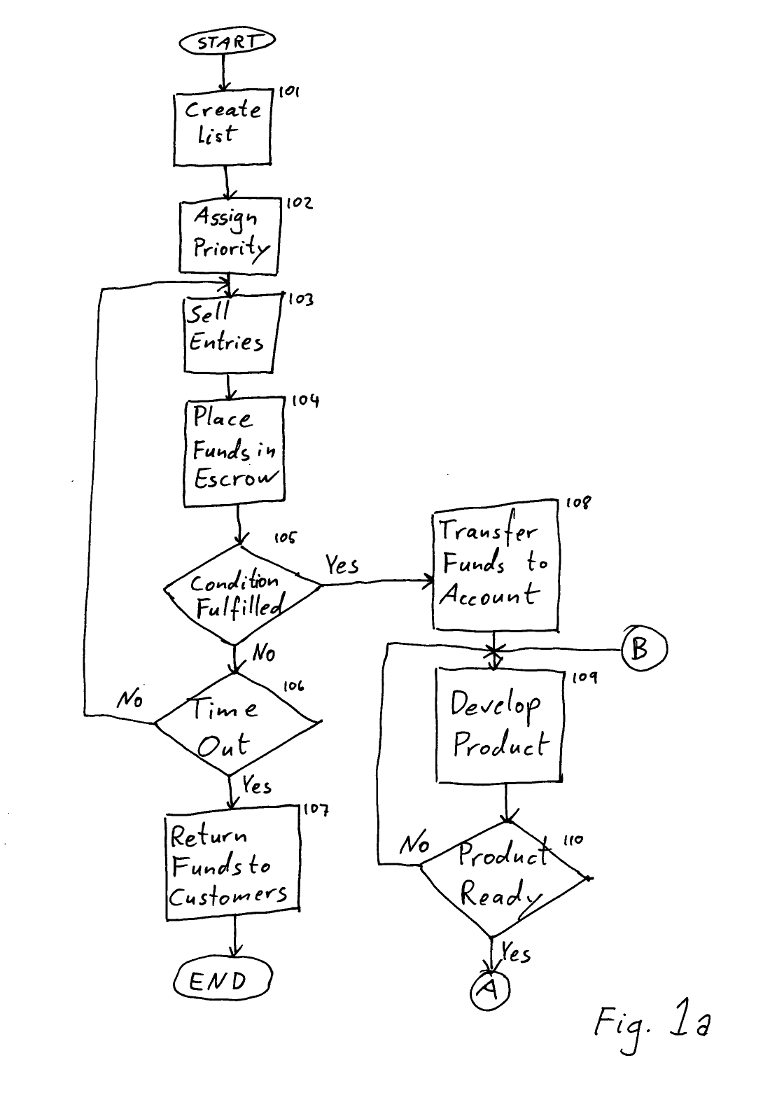

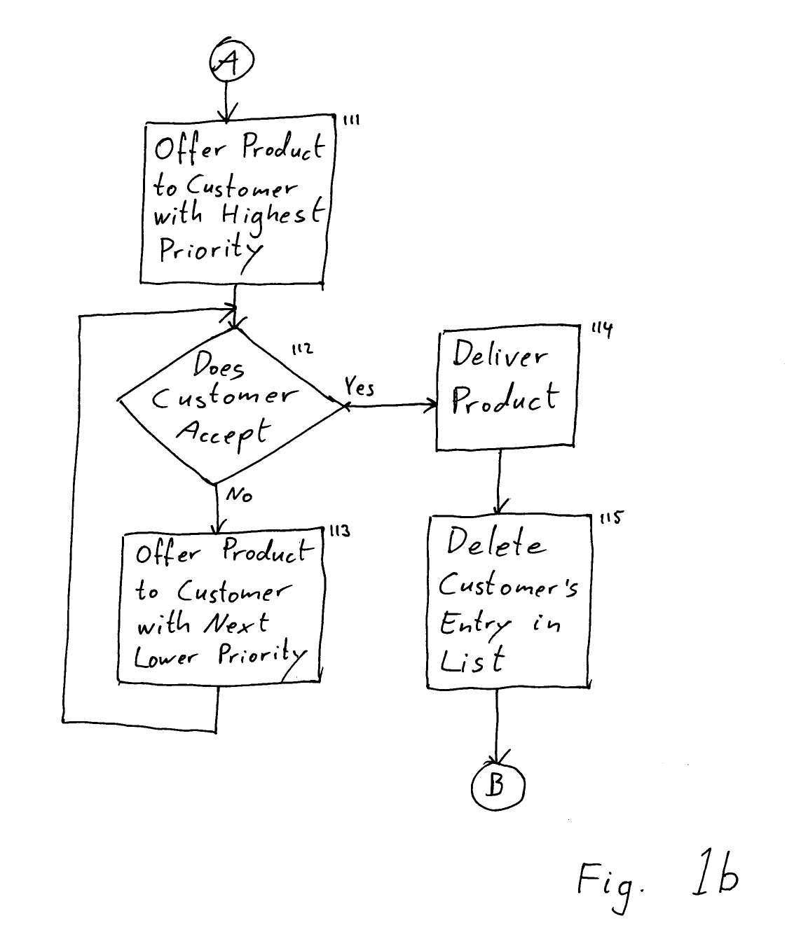

FIGS. 1a and 1b show an exemplary flowchart illustrating the various actions and decisions involved in an embodiment of the invention where the funding of a product development project may be achieved through pre-sale of the products to be developed.

In a first step 101 a list is created. Each entry in the list represents the sale of a future product that remains to be developed or manufactured. Each entry in the list is assigned a priority (step 102) for product delivery. This means that customers who have bought an entry with high priority will be offered products, as they become available, before customers with a lower priority.

It should be noted that the terms buying an entry and buying a product will be used interchangeably, but that the entry also may represent an option to buy a future product, or a down payment on a future product. In other words, the payment for the entry may represent payment for the product in full or in part, or it may only represent the right to be offered a product that will have to be paid in full when an offered product is accepted.

As entries (or products) are sold (step 103), the funds received are placed in an escrow account (step 104). The price of an entry is a function of the priority associated with that entry, as further described below.

The sale of entries (step 103) and accumulation of funds in escrow (step 104) continues as long as a given condition (step 105, NO) is not fulfilled, but the time out period for the condition (step 106), has not been reached. If the time out period (step 106) is reached without the condition (step 105) being fulfilled, all funds held in escrow are returned to the customers (step 107), and the project is terminated.

If the condition (step 105, YES) is fulfilled before time out, all funds in escrow are transferred to a second account (step 108). It should be noted that a plurality of conditions may exist, and that some conditions may only trigger release of parts of the funds, possibly with restrictions as to what they can be used to fund. This will be described in further detail below.

Various conditions can be used in step 105. The condition may for example be the sale of a predetermined number of entries in the list (or products), the sale of the entry (or a number of entries) with the highest priority, or the accumulation of a certain minimum amount of funds in the escrow account, etc.

The condition may also be a set of conditions out of which one, some or all must be fulfilled, and in the case where funds are allocated into several sub-accounts based on e.g. an indicated preference from the customers, different conditions may apply to the different sub-accounts.

Whether sale of entries continues after the condition in step 105 has been met and funds have been transferred, may depend on the nature of the project in each case. In some cases sale of entries may go on, the only difference being that funds are now placed directly in the second account. In other cases funds received from sales following the fulfillment of the predetermined condition are still placed in the escrow account and a new condition is set for a future transfer of these funds to the second account.

The latter alternative may be desirable when the number of pre-sales represents such a long waiting list that this introduces new uncertainty regarding future deliveries.

Cases where sale of entries are terminated may include a situation where a limited number of products will be produced and the condition is the sale of all of them, for example, if the product is attendance at an event with a limited capacity, or the production of a limited one-time series of a particular product. Another example may be where sufficient funding through pre-sale creates an opportunity for a change of business model where traditional investment may be available and/or sale of products will be by more traditional sales methods.

After funds have been transferred to the second account (step 108) they become available for product development (step 109). Product development continues until a product is ready (step 110), and possibly also beyond this point. When a product is finally ready to be delivered (step 110), the product is offered to the customer with the highest priority (step 111), as shown in FIG. 1b.

If the customer with the highest priority does not accept the product (step 112, NO), the offer is passed on to the customer with the next lower priority (step 113). This continues until a customer accepts the product (step 112, YES). The product is then delivered (step 114) and the customer's entry is deleted from the list (step 115). Product development (step 109) continues until a new product is ready to be offered to a customer, and the steps of offering the product to customers are repeated.

It should be noted that some of the steps illustrated in FIGS. 1a and 1b may be performed in parallel, or in an overlapping manner. In an example that will be discussed further below involving tissue engineering, the development of the product and the product will be one and the same. In this case the product is so highly personalized that development will not start at all before a customer has accepted. In other words the development phase and the actual product are parts of the same product and/or service.

The method will now be explained by way of an example in which the product to be developed is any one of a number of artificially grown organs produced through tissue engineering based on the customer's own DNA. The explanation of this example will not go into any detail regarding the biotechnology issues involved, since they are outside the scope of the invention. The example will, however, illustrate how the method may be performed when there is a plurality of products to choose from, and where product development and product delivery is an integrated process.

According to this exemplary embodiment the method is used to fund a project for development and delivery of replacement organs for patients based on the individual patient's own DNA. The organs or tissue to be developed belong, for the purposes of this example, to the following product groups: liver tissue, pancreas tissue, kidney tissue, heart tissue and lung tissue.

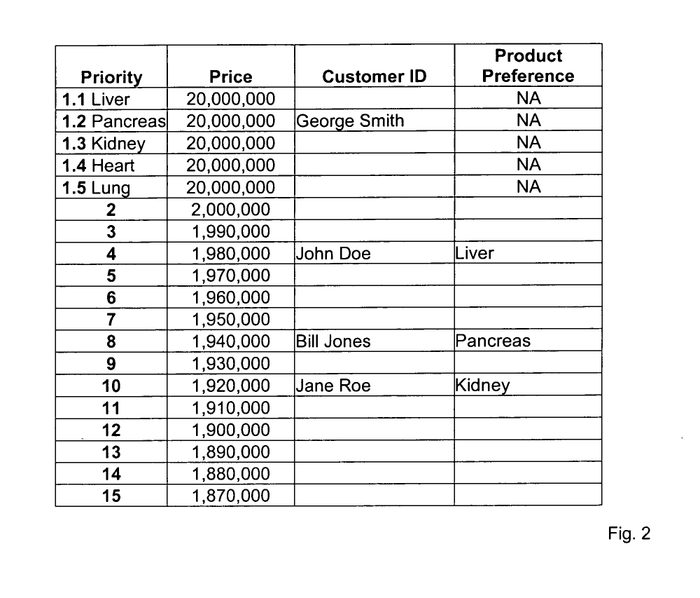

As illustrated in FIG. 2, a list is created wherein each entry represents the sale of an artificially grown organ. According to this example the list includes four columns. In a first column 200 the priority for product delivery is indicated. A lower number indicates higher priority. Note that the top five entries have the same priority, but they are all associated with a selected product. This means that the holder of entry 1.2 has priority before everybody else for acceptance of a product as long as that product is a pancreas, or pancreas tissue. Similarly, entry 1.1 represents the highest priority for acceptance of a liver type product.

The second column 202 of the list indicates the price associated with that entry. It will be noted that the price is dependent on the priority, such that a higher priority gives a higher price. The prices indicated here are exemplary only; any price/priority profile or strategy may be employed as the method is adapted to the particular circumstance of each individual case.

The third column 204 identifies a customer who has purchased an entry in the list and thus a product. In this example four entries have been sold, and it will be noted that they have been sold at the customer's preference, i.e. not from the top of the list.

The fourth and final column 206 of the list according to this example is an indication of product preference. This column may not be present if only one product is to be developed, or if customers make their choice to accept or pass only as a product is actually offered to that customer. The column may be used in cases where funds received upon sale of an entry should be held in escrow and/or transferred from escrow based upon the customer preference at the moment of sale. It may also be useful in other cases in order to predict the acceptance rate of the various products to be developed.

It should be noted that for the five number one entries 208 the customer cannot enter any preference, since these entries in this example represent the acceptance of a defined product.

As the entries in the list shown in FIG. 2 are sold, considerable funds will be accumulated in the escrow account. This means that when a predetermined condition for release of these funds is fulfilled, the organization, person or entity responsible for developing the products will have access to funds without having to find investors willing to accept the risk. Instead, the risk is accepted by customers based on their need for the product to be developed. However, the risk taken by customers is reduced by the fact that, unless sufficient funds can be accumulated within a predetermined time limit, all funds held in escrow are returned.

In a conventional pre-sale scenario, funds are held in escrow and returned upon nonperformance or nondelivery. Since funds are held in escrow during the development and production of the product, this does not provide any funds that can be used for development, and investors would still be needed. If, on the other hand, pre-sale funds were released immediately, the development organization might run out of funds before being able to deliver. The organization would then be bankrupt, and no funds would be recoverable by the customers.

The predetermined condition that must be fulfilled could, as described above, be the accumulation of a certain minimum of funds in the escrow account, or the sale of a certain number of entries in the list. In the present example the condition could be the sale of one of the entries with priority “1”. Other conditions or combination of conditions are possible, as discussed above.

The list shown in FIG. 2 could then be the result a first sale to John Doe, who buys the entry with priority 4 and enters a preference for a liver tissue product. His payment is received and placed in an escrow account. Subsequent customers include Jane Roe and then Bill Jones, who choose the entries representing product delivery priority 10 and 8, respectively. All funds are still held in escrow. These events correspond with steps 101 through 106 in FIG. 1a, described above.

The customer George Smith buys a number 1 entry, representing the purchase of a pancreas. Funds held in escrow are now released and product development can commence, as illustrated in FIG. 1, step 108.

According to this example, the purchase of a top priority entry also represents acceptance of the product, which means that steps 109 and 110 in FIG. 1a are performed simultaneously with the steps of FIG. 1b.

According to this example the developer has the capacity to run five simultaneous development tracks, one for each product. After George Smith receives his new pancreas his entry is deleted from the list, steps 114 and 115 of FIG. 1b, and the method returns to step 109 of developing a new product.

In this example it is assumed that the initial delivery of a product from one of the five product groups enables the developer to deliver additional products at a lower cost. In other words, the developer is able to offer a pancreas product to the person with the highest priority after the deletion of George Smith's entry. The developer is not, however, ready to offer any of the other products until one of the corresponding top priority entries have been sold. This means that an offer to accept a new pancreas will go first to John Doe, who will most likely not accept since his preference is for a liver tissue based product. The offer will then go to Bill Jones, who most likely will accept, since his listed preference is for a pancreas. However, Bill Jones' preference may have changed so he may also pass and retain his entry in the list. These steps are illustrated as steps 111 through 113 of FIG. 1b.

According to circumstances it would of course be possible to offer development/delivery of any of the five products as soon as George Smith is removed from the list. However, when it can be assumed that the first delivery will be a lot more costly than subsequent deliveries, the method according to some principles of the present invention makes it possible to offer only the products that are available, in this case either through the purchase of a top priority entry that has not already been purchased, or through the acceptance of a product after it has been successfully been delivered to another customer.

So while the second offer for a pancreas will pass to Bill Jones with priority 8, John Doe will have to wait until entry 1.1 has been purchased and delivered before he will be given and may accept an offer for a liver.

Principles consistent with some embodiments of the present invention also allow for other conditions or combination of conditions to trigger release of funds and/or initiation of parallel development, production and delivery tracks, for instance through an association between funds and product group or type based on indicated preference of customers when they purchase an entry in the list.

As already described, the customers achieve a certain security through the use of an escrow account and the guaranteed return of funds if development would be underfunded. Additional security can be achieved by making the entries in the list tradable. Even if the predetermined condition is fulfilled and product development starts, this is not a guarantee that a particular product will be offered to a customer by the time he or she needs it. In the case illustrated in FIG. 2, John Doe may still be waiting for his liver after George Smith and Bill Jones have received their pancreas, and he may decide that he is not willing to wait any longer. He may then sell his entry to somebody who is interested in taking over. Since the preference of an entry can be changed at any time until a product is actually accepted, the person purchasing the entry may be interested not in a liver, but in a pancreas, which is a product that, according to this example, has already been delivered and that may soon become available again.

In the example just described, there are still entries available with a higher priority than that of John Doe at entry number 4, so he may not be able to recover all his funds, but he may be able to recover a substantial amount, and some other customer will be able to purchase an entry at a discount. In the case where all entries with a comparable priority had already been sold, John Doe might even be able to sell his entry with a profit. In order to avoid speculation, the number of entries that can be owned by the same person can be limited to a certain number.

The risk for the customer can be reduced even more through the introduction of a payment plan. As an example payment could be divided into three installments, with a 50% down payment upon purchase of the entry in the list, 25% at acceptance/order of product and 25% at delivery. In the tissue engineering example acceptance could be defined as before or after clinical testing to determine whether the customer is a suitable candidate for receiving organs produced through tissue engineering, and delivery could be defined as implantation of tissue in the customer's body, or when some other predefined medical milestone has been passed.

It will be understood that such a payment plan may also be realized in such a manner that the entry into the list represents the purchase of an option to buy, while the acceptance of an actual product represents the sale.

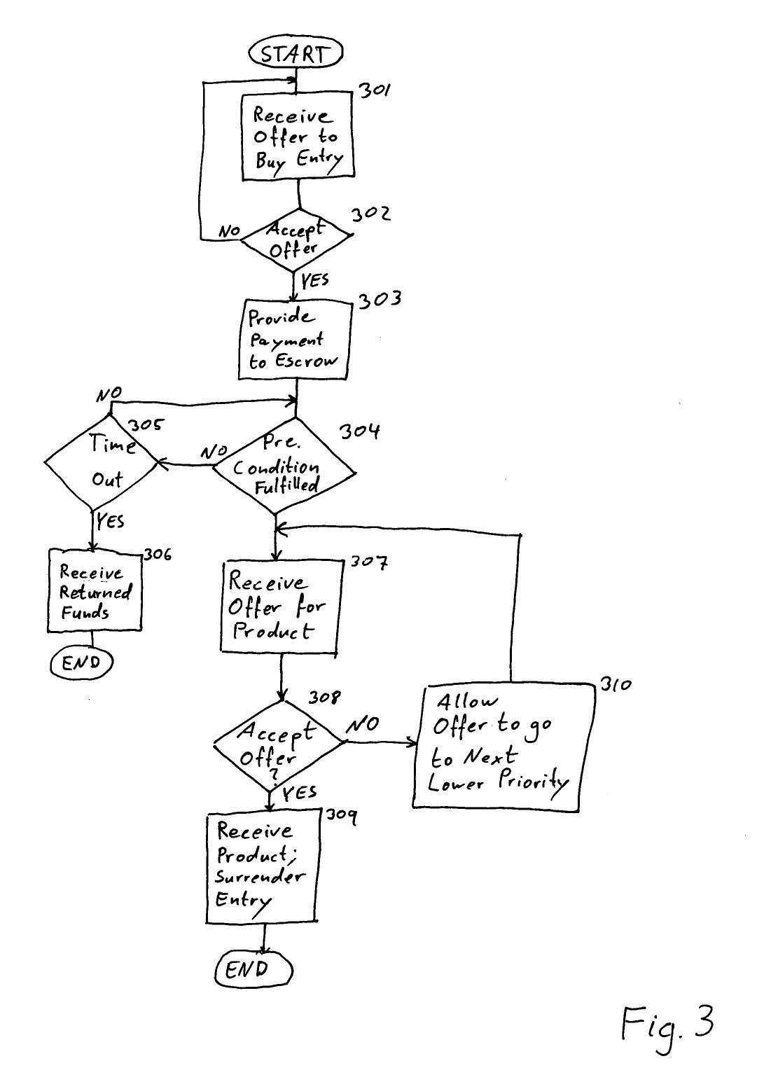

Turning now to FIG. 3, where exemplary embodiments of the method as performed by a customer are depicted. In a first step 301, a customer receives an offer to purchase a future product, or a right to a future product, and being entered in a list of entries where each entry is associated with a product delivery priority. The customer may then have the option to accept the offer (step 302, YES), or alternatively to reject the offer. If the customer rejects the offer (step 302, NO) he may go back to wait for a new offer, or in other embodiments consistent with the invention the method simply ends. If the customer accepts the offer to purchase an entry in the list he or she must provide payment (step 303) in some form acceptable to the person or entity offering the pre-sale in order for this payment to be placed in an escrow account.

The funds placed in escrow remains there until a predetermined condition is fulfilled, as described above. If the condition is not fulfilled (step 304, NO) and a defined time out for fulfillment of the condition has not been reached (step 305, NO) the customer simply continues waiting. If time out is reached without the condition being fulfilled (step 305, YES), the customer receives the funds back from the escrow account (step 306), and the method ends.

If the predefined condition is fulfilled (304, YES) the funds held in escrow will be released towards product development and/or production, as already described. When this results in a product being available it will be offered to customers based on product delivery priority. Eventually, how early or late will depend on the priority associated with his or her entry in the list, the customer may receive an offer to accept a product (step 307). The customer may then choose to accept (step 308, YES), and in this case the customer receives the product, surrenders the entry in the list, and the method has reached an end. If the customer chooses not to accept (step 308, NO) the customer allows the offer to go to the customer with the next lower priority (310) and waits for a new offer (step 307).

It is understood how the customer, by employing the principles discussed herein, may be able to contribute towards development or production of certain products or services by providing funds, while at the same time retaining a high degree of control and security.

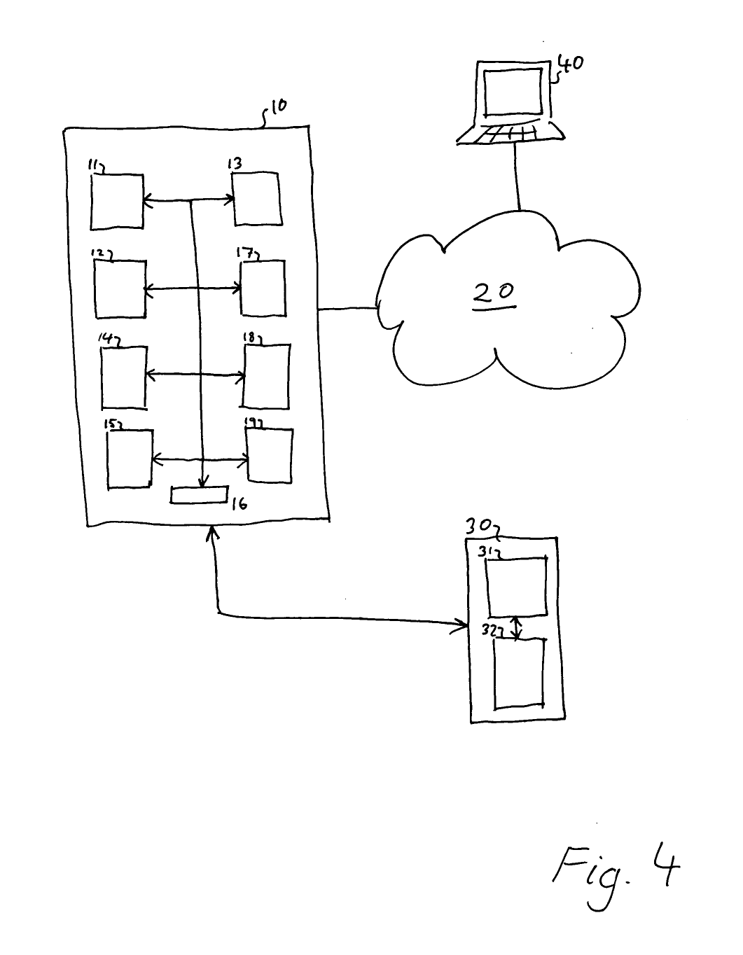

Reference is now made to FIG. 4, which shows a computerized system for performing and/or administrating the method according to the invention.

The system 10 includes a memory 11 for storing a list of entries representing a sale of a future product, as already described above. The memory may be internal system memory, or a database accessible from the system 10. The system further includes a central processing unit 13 for executing instructions stored in the modules and input/output devices 16 for facilitating receipt and transmission of data. The system 10 further includes a registration module 12 for receiving information to be entered in the list, such as information identifying a customer having purchased a product and information identifying the entry, or priority, the customer has chosen to buy. The received information may also include information specifying a product preference.

The system 10 further comprises an electronic payment module 14 for receiving electronic payment for an entry in the list. The electronic payment module 14 is able to communicate with a banking system 30 where at least two accounts 31, 32 are associated with the system. The first account is an escrow account 31 to which all payment received by the electronic payment module 14 is transferred, at least until a predefined condition has been fulfilled, as will be described further below. The second account 32 is an account that receives funds that have been released from the escrow account 31.

A monitoring device 15 is configured to detect the fulfillment of a predefined condition, and upon such fulfillment, transmit to the electronic payment module 14, an authorization to transfer funds from the escrow account 31 to the second account 32.

According to some embodiments consistent with the present invention, the monitoring device 15 monitors the list stored in the system memory 11. However, the monitoring device 15 may also monitor e.g. the escrow account through communication with the banking system 30, or it may depend on operator input.

The predetermined condition may be the entry of customer identification data in a number of entries in the list stored in system memory 11, completed entries associated with certain predefined priorities, an accumulated amount in the escrow account 31, or any other condition that is relevant and that may be detected by the monitoring unit, in accordance with design choices made in each case.

The system 10 may be configured to receive notification that a product is available. A communication module 17 may be configured to transmit an offer to accept the available product to the customer identified in the entry in the list with highest priority. The communication module 17 may e.g. be configured to create and send e-mail notifications over the network 20 to a customer terminal 40, and receive notifications of acceptance or rejection of the offer. This can be implemented as a script or other software operating in conjunction with commercially available e-mail server software.

The registration module 12 then processes the information received by the communication module 17. If the received information represents an acceptance, the registration module 12 transmits an authorization to deliver the product to a product delivery subsystem 18, and deletes the customer's entry from the list in memory 11. The product delivery subsystem 18 may simply represent a notification to a human operator that product delivery may be initiated, but to the extent that product delivery can be automated, it may also be some sort of an automated system for production and/or transmission.

In the event that the information received from the customer by the communication module 17 is a rejection of the offer, the registration module 12 instructs the communication module 17 to repeat the transmission of the offer, but this time to a customer with the next lower priority relative to the customer from whom the rejection was received.

The system described above may be configured and/or programmed to perform more sophisticated operations in accordance with what has been described with reference to FIG. 1a and 1b and FIG. 2. As an example, when product preference is received and stored in the list in memory 11 upon sale of an entry, the electronic payment module 14 may be configured to transfer the received payment to a sub-account of the escrow account 31 corresponding with the identified product group preference. It will be realized that the sub-accounts do not have to be different bank accounts of the banking system 30. The escrow account may as an example be one bank account in the banking system 30 while the sub-accounts are realized through relevant book keeping in the system 10, stored in system memory 11.

The monitoring device 15 may be configured to discriminate between different predefined conditions associated with one of said plurality of sub-accounts and a corresponding one of said plurality of product groups. For instance, referring back to the example of FIG. 2, the criteria associated with a kidney product group may depend on the sale of a certain number of entries where a kidney product preference is indicated, or upon the sale of entry 1.3, the entry with the top priority for a kidney delivery.

In such an embodiment of the system 10, the monitoring device 15 would then be configured to issue authorizations for release of funds from the escrow sub-account with which the fulfilled condition is associated and to a sub-account of the second account. This sub-account of the second account may then hold funds that are available for product development and/or production only of products belonging to the product group for which the condition was fulfilled and the escrow sub-account was associated.

The monitoring device 15 may also be configured to detect that no predetermined condition has been fulfilled within a predetermined time, and to issue an authorization through the electronic payment module to return funds from the escrow account 31 to accounts belonging to the respective customers represented in the list in memory 11.

Finally, the system 10 may include an e-commerce subsystem 19. Such a subsystem could e.g. be a web-shop connected to the communication network 20, which could typically be the Internet, and capable of offering a product (and/or the corresponding entry in the list) for sale. The system would then be configured to transmit payment information received from a customer 40 to the electronic payment module 14, transmit customer information to the registration module 12 for entry into the list in memory 11, and updating the offer displayed to subsequent customers.

If products are sold on a sequential basis, the price may simply be reduced for subsequent customers. But in some embodiments where customers can choose their priority, the chosen price/priority combination will have to be removed from a list of price/priority options, or otherwise be disabled.

The e-commerce subsystem 19 may also be configured to present a trading place for customers that want to buy or sell an already purchased entry in the list. The subsystem 19 may then be configured to receive information regarding an entry that is offered for sale by a customer who is already registered in the list in system memory 11 and present this as an offer for trade. Furthermore, the e-commerce subsystem may be configured to utilize the electronic payment module 14 to receive payment on behalf of sellers. The e-commerce subsystem 19 may in this case transfer update information to the registration module 12 identifying the entry that has been traded and the customer who is the new owner of the entry, and delete the offer for trade from the web-shop.

Authorization and other security measures surrounding the use of electronic payment systems and e-commerce systems are well known in the art and should be implemented in accordance with design criteria.

While the system has been described as a number of discrete modules, devices and subsystem in a computerized system, it will be realized that the actual implementation may vary in the sense that several modules may be part of one larger subsystem, or functionality may be replicated over several modules. The system memory 11 may be internal system memory or one or more internal hard drives on the system 10, or an external database, or a combination of these. The electronic payment module 14 may communicate directly with the banking system, or it may be in communication with an external electronic payment system possibly provided by a third party.

The e-commerce subsystem 19 may be operating directly on the contents in memory 11 as an integrated module along with the other modules described, but it may also reside on one or more separate web servers that is in communication with the other modules of the system 10 and transmits and receives data with these whenever this is necessitated as a result of transactions.

Furthermore, the communication between subsystems, main system and banking system, while shown as taking place over dedicated lines and system buses, may also be conducted over the publicly accessible network 20.

It will be readily understood that the invention is not limited to the features described in the above example, and that the method will be useful and provide concrete and tangible results in a variety of circumstances, only limited by the definitions of the attached claims.

What is claimed:

1. A system for administrating funding of product development, comprising:
a memory for storing a set of instructions;
a processor for executing the set of instructions stored in memory to perform a method comprising:
establishing a list of entries;
assigning a priority to each entry in said list;
associating identifying information with at least one entry; and
issuing an instruction upon determination that a predetermined condition has been fulfilled.

2. The system according to claim 1, wherein said predetermined condition is the association of identifying information with a predetermined number of entries in said list.

3. The system according to claim 1, wherein said predetermined condition is the association of identifying information with the entry in said list to which a highest priority has been assigned.

4. The system according to claim 1, wherein the processor is further configured to execute the instruction of issuing an alternative instruction when the predetermined condition has not been fulfilled within a predetermined time.

5. A system for administrating funding of product development through pre-sale of products to be developed, comprising:
a memory for storing a list of entries, each entry being assigned a priority;
a registration module for receiving information identifying a customer and registering said customer identification information in said list in accordance with a corresponding priority;
an electronic payment module capable of receiving electronic payment information corresponding with an entry of customer identification information in said list, and transmitting instructions indicating that funds relating to said payment information is to be placed in an escrow account in a banking system; and
a monitoring device configured to detect the fulfillment of a predefined condition, and upon such fulfillment, transmit information representing an authorization to transfer funds accumulated in said escrow account to a second account in said banking system.

6. The system according to claim 5, wherein said predetermined condition is the registration of customer identification information in a predetermined number of entries in said list.

7. The system according to claim 5, wherein said predetermined condition is the registration of customer identification information in an entry with the highest priority in said list.

8. The system according to claim 5, further comprising:
a communication module configured to receive information identifying that a product is available, to transmit an offer to accept said product to the customer identified in the entry associated with the highest priority in said list, and to receive information representing acceptance or rejection of said offer from said customer; and
the registration module being further configured to handle information received by said communication module and
on receipt of an acceptance of an offer, transmit to a product delivery subsystem, an authorization to deliver said product to the customer from whom acceptance is received and delete the entry containing an identification of said customer from the list; and
upon receipt of a rejection of an offer, instruct said communication module to transmit said offer to the customer identified in the entry associated with the priority with the next lower priority relative to the customer from whom said rejection was received.

9. The system according to claim 5, wherein said information received by said registration module may include information identifying a product group preference to be entered in said list together with said customer identification information,
said electronic payment module is configured to instruct the placement of said payment in a sub-account of said escrow account corresponding with the identified product group preference; and
said monitoring device is configured to discriminate between predefined conditions associated with at least one of said plurality of escrow sub-accounts and a corresponding one of said plurality of product groups.

10. The system according to claim 9, wherein said monitoring device is further configured to, upon detection of fulfillment of a condition associated with at least one of said plurality of escrow sub-accounts and a corresponding one of said plurality of product groups, transmit instructions representing an authorization to transfer funds accumulated in the escrow sub-account associated with that product group to a sub-account of said second account, said sub-account of the second account holding funds available for product development or production only of products belonging to the product group associated with the escrow sub-account from which the funds are transferred.

11. The system according to claim 5, wherein said monitoring device is further configured to transmit, upon detecting that no predetermined condition has been fulfilled within a predetermined time, information representing an authorization to transfer said funds held in said escrow account back to customers owning entries in said list.

12. The system according to claim 5, further comprising an e-commerce subsystem connected to a publicly accessible communication network and capable of presenting information accessible from said communication network and representing a product for sale at a given price and with a given product delivery priority, and upon each sale:
transmitting electronic payment information to said electronic payment module; and
transmitting information identifying a customer having purchased a product to said registration module.

13. The system according to claim 12, wherein said e-commerce subsystem is configured to, upon each sale, reduce said price and product delivery priority.

14. The system according to claim 12, wherein said information representing a product for sale is presented as a list of product delivery priority and price options from which a customer can choose, and where lower priority is given a lower price, and the system is configured to, upon each sale, remove or otherwise disable the selected product delivery priority and price from said list of product delivery priority and price options.

15. The system according to claim 5, further comprising an e-commerce subsystem connected to a publicly accessible communication network and capable of receiving information indicating that an identified entry in the list that has already been sold is offered for trade by the owner, present the entry in a list of entries available for trade, and, upon each trade:
transmitting, to the electronic payment module, instructions to receive payment on behalf of an identified seller;
transmitting, to the registration module, information identifying a customer having purchased a product and an identification of the traded entry; and
removing the entry from the list of entries available for trade.

16. A method for funding product development through pre-sale of products to be developed, comprising:
establishing a list of entries where each entry represents a sale of a future product;
assigning a priority for product delivery to each entry in said list;
offering entries in said list for sale;
receiving notification of at least one sale of an entry in the list;
holding the funds resulting from any sales of entries in the list in an escrow account until a predetermined condition has been fulfilled; and
transferring the funds from said escrow account to a second account holding funds available for product development or production when said predetermined condition has been fulfilled.

17. The method according to claim 16, wherein the price of each entry is a function of the priority associated with the entry.

18. The method according to claim 16, wherein said predetermined condition is the sale of a predetermined number of entries in said list.

19. The method according to claim 16, wherein said predetermined condition is the sale of the entry with the highest product delivery priority in said list.

20. The method according to claim 16, wherein a customer owning an entry in said list, upon availability of a product not accepted by a customer owning an entry with a higher priority, is presented with the option to:
accept the product and have his or her entry in the list deleted, or
defer, retain the entry in the list, and pass the option to accept the product to the customer owning the entry with the next lower priority.

21. The method according to claim 16, further comprising:
allocating the funds held in said escrow account into a plurality of sub-accounts each associated with one of a plurality of product groups, and based on a product group preference associated with entries in said list; and
establishing said predetermined condition as a set of a plurality of conditions each associated with at least one of said plurality of sub-accounts and a corresponding one of said plurality of product groups.

22. The method according to claim 21, further comprising:
upon fulfillment of a condition associated with one of said plurality of sub-accounts and a corresponding one of said plurality of product groups, transferring the funds from the escrow sub-account associated with that product group to a sub-account of said second account, said sub-account of the second account holding funds available for product development or production only of products belonging to the product group associated with the escrow sub-account from which the funds are transferred.

23. The method according to claim 16, wherein said products are developed through tissue engineering.

24. The method according to claim 23, wherein said products are taken from the group consisting of liver tissue, pancreas tissue, kidney tissue, heart tissue and lung tissue.

25. The method according to claim 16, further comprising:
returning said funds held in said escrow account to customers owning entries in said list if said predetermined condition is not fulfilled within a predetermined time.

26. The method according to claim 16, wherein entries in said list are sold sequentially, where an earlier customer pays a higher price and gets a higher priority than subsequent customers.

27. The method according to claim 16, wherein entries in said list are sold according to customer preference, such that an earlier customer can choose to buy an entry with a lower priority and lower price than subsequent customers.

28. The method according to claim 16, further comprising storing said list on a computer system.

29. The method according to claim 28, wherein said computer system is configured to store information representing an offer for sale of entries in said list as information accessible from a computer network.

30. The method according to claim 28, wherein said computer system is configured to evaluate said predetermined condition, and upon fulfillment of said condition, to transmit instructions to an electronic banking system authorizing said transfer of funds from said escrow account to said second account.

31. The method according to claim 16, further comprising receiving a notification to change the customer name entered as an entry in the list as a result of a trade between customers.

32. A method of providing funds towards product development by buying through a pre-sale a product to be developed, comprising:
receiving an offer to purchase an entry in a list where each entry represents a sale of a future product;
giving notification of acceptance of said offer to purchase an entry, said entry being associated with a defined priority for product delivery; and
providing payment for the purchase in the form of funds to be held in an escrow account until a predetermined condition has been fulfilled.

33. The method according to claim 32, wherein said predetermined condition is the sale of a predetermined number of entries in said list.

34. The method according to claim 32, wherein said predetermined condition is the sale of the entry with the highest product delivery priority in said list.

35. The method according to claim 32, further comprising:
receiving notification that a product is available;
upon receiving said notification either:
accepting the product and surrendering the entry in the list; or
deferring, retaining the entry in the list, and passing the option to accept the product to the customer owning the entry with the next lower priority.

36. The method according to claim 32, further comprising:
upon giving notification of acceptance, also giving notification of a preferred product group.

37. The method according to claim 32, wherein said products are developed through tissue engineering.

38. The method according to claim 37, wherein said products are taken from the group consisting of liver tissue, pancreas tissue, kidney tissue, heart tissue and lung tissue.

39 The method according to claim 32, further comprising:
if said predetermined condition is not fulfilled within a predefined time, receiving said funds in return.

40. The method according to claim 32, wherein the offer received is an offer to purchase the entry associated with the highest priority for product delivery of all unsold entries in the list.

41. The method according to claim 32, wherein the offer received is an offer to select a preferred price and priority combination from remaining unsold entries in the list, the method further comprising:
upon giving notification of acceptance of the offer to buy an entry in said list, including information of a selected price and priority.

42. A computer program product containing a set of instructions, which when executed by one or more computer processors, will perform the method of claim 16.
